(19) United States
(12) Patent Application Publication
(10) Pub. No.: US 2026/0340353 A1
(43) Pub. Date: Oct. 29, 2026

(54) SELECTION-INFERENCE NEURAL NETWORK SYSTEMS

(71) Applicant: DeepMind Technologies Limited, London (GB)

(72) Inventors: Antonia Phoebe Nina Creswell, London (GB); Murray Shanahan, London (GB)

(21) Appl. No.: 19/107,903

(22) PCT Filed: Aug. 30, 2023
(86) PCT No.: PCT/EP2023/073796

§ 371 Date: Feb. 28, 2025

Related U.S. Application Data
(60) Provisional application No. 63/402,382, filed on Aug. 30, 2022.

(51) Int. Cl. G06N 3/0475; G06N 3/045

(52) U.S. Cl. CPC G06N 3/0475; G06N 3/045

(57) ABSTRACT

Methods, systems, and apparatus, including computer programs encoded on a computer storage medium, for generating a response to a query input using a selection-inference neural network.

### CROSS-REFERENCE TO RELATED APPLICATION

This application claims priority to U.S. Provisional Application No. 63/402,382, filed on Aug. 30, 2022. The disclosure of the prior application is considered part of and is incorporated by reference in the disclosure of this application.

### BACKGROUND

This specification relates to generating a response to a query input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates a response to a query relating to an environment.

In particular, the system receives a context input that includes context information relating to the environment and a query input that includes a query relating to the environment.

The system then uses the context input to generate a response, e.g., a natural language response, to the query.

The system generates the response by repeatedly alternating between performing selection steps and inference steps. As a result, the system can also generate trace data that provides natural language, interpretable information characterizing how the system arrived at the response.

In one aspect, a method includes obtaining a context input comprising context information, the context information comprising one or more natural language statements that each represent a fact or a rule relating to an environment; receiving a query input comprising a query relating to the environment; generating a response to the query input by performing update iterations until a termination criterion is satisfied, the generating comprising, at each update iteration: processing a selection input comprising the context input and the query input using a selection neural network to generate a selection output for the update iteration that comprises one or more of the natural language statements from the context input; processing an inference input comprising the selection output for the update iteration using an inference neural network to generate an inference output that comprises a natural language statement that represents a new fact for the update iteration; generating, based on the inference output for the update iteration and the query input, a first halting input; processing the first halting input using a first halting neural network to generate a first halting output that indicates whether the inference output contains information necessary to respond to the query input; and determining whether the termination criterion is satisfied based on the first halting output.

In some implementations, the generating further comprises, in response to determining that the termination criterion is not satisfied, updating the context input to include the natural language statement in the inference output for the update iteration.

In some implementations, the method further comprises determining that the termination criterion is satisfied when the halting output indicates that the inference output contains the information necessary to respond to the query input.

In some implementations, the method further comprises: determining that the termination criterion is satisfied when the halting output indicates that the inference output does not contain the information necessary to respond to the query input but a maximum number of update iterations have been performed.

In some implementations, the generating further comprises, in response to determining that the inference output does not contain the information necessary to respond to the query input but a maximum number of update iterations have been performed, providing, as the response, a natural language output that indicates that that the query has not been answered.

In some implementations, the method further comprises: in response to determining that the halting output indicates that the inference output does contain the information necessary to respond to the query input, providing, as the response, (i) a natural language output derived from the natural language statement in the inference output for the last update iteration.

In some implementations, the response further comprises (ii) a reasoning trace that comprises the natural language statement in the inference output at each update iteration other than the last update iteration.

In some implementations, the reasoning trace further comprises the selection outputs for the update iterations.

In some implementations, the method further comprises: generating a second halting input from at least the inference output at the update iteration; and processing the second halting input using a second halting neural network to generate a second halting output that identifies the natural language output derived from the natural language statement in the inference output for the last update iteration.

In some implementations, the second halting neural network is the same neural network as the first halting neural network.

In some implementations, the first and second halting neural networks are a language model neural network, wherein the first halting input includes a first halting text prompt and wherein the second halting input includes a second, different halting text prompt.

In some implementations, the query input further comprises a plurality of natural language choices, wherein the second halting input further comprises the plurality of natural language choices, and wherein the second halting output identifies one of the plurality of natural language choices as the natural language statement.

In some implementations, the inference input does not include the query input or any natural language statements from the context input that are not included in the selection output for the update iteration.

In another aspect, a method includes obtaining a context input comprising context information, the context information comprising one or more natural language statements that each represent a fact or a rule relating to an environment; receiving a query input comprising a query relating to the environment; and generating a response to the query input conditioned on the context input, comprising, at each beam step of a sequence of one or more beam steps: obtaining a plurality of candidate reasoning traces generated by a selection-inference system as part of generating a response to the query input conditioned on the context input, each candidate reasoning trace comprising, for each of one or more update iterations, a respective selection output for the update iteration and a respective inference output for the update iteration; and maintaining at most a predetermined number of the candidate reasoning traces in a beam for further consideration by the selection-inference system, comprising: processing each reasoning trace using a value neural network to generate a respective score for each reasoning trace that estimates a likelihood that the candidate reasoning trace is a valid reasoning trace that is included in a ground truth reasoning trace that results in a ground truth response to the query input; ranking the candidate reasoning traces based on the respective scores; and removing from the beam all candidate reasoning traces other than the predetermined number of highest-ranked candidate reasoning traces according to the ranking.

In some implementations, generating the response further comprises: at a last beam step in the sequence, determining that each candidate reasoning trace that was not removed from the beam has been finalized and, in response, generating the response based on the highest-ranked candidate reasoning trace.

In some implementations, the value neural network is configured to generate a value output that specifies a probability distribution over a vocabulary of tokens, and wherein the score is based on a probability assigned by the probability distribution to a predetermined token from the vocabulary.

In some implementations, the value neural network is a language model neural network.

In some implementations, the value neural network has been trained on training examples that each comprise (i) a respective partial reasoning trace and (ii) a label indicating whether the partial reasoning trace was a valid reasoning trace included in a corresponding complete reasoning trace.

In some implementations, the method further comprises: at each beam step other than the last beam step in the sequence, determining that at least one of the candidate reasoning traces that were not removed from the beam has not been finalized and, in response, causing the selection-inference system to generate, for each candidate reasoning trace that was not removed from the beam and that is not finalized, a respective selection output for a new update iteration that follows a last update iteration in the candidate reasoning trace and a respective inference output for the new update iteration.

In some implementations, the selection-inference system is a system that is configured to: obtain the context input; receive the query input; receive a current candidate reasoning trace that includes, for each of one or more update iterations, a respective selection output for the update iteration and a respective inference output for the update iteration; and perform a new update iteration to update the current candidate reasoning trace to add a new selection output and a new inference output to the candidate reasoning trace, comprising: processing a selection input comprising (i) the context input, (ii) one or more natural language statements derived from the respective inference outputs in the candidate reasoning trace, and (iii) the query input using a selection neural network to generate the new selection output for the new update iteration that comprises one or more of the natural language statements from the context input, one or more of the natural language statements derived from the respective inference outputs, or both; and processing an inference input comprising the selection output for the new update iteration using an inference neural network to generate the new inference output, wherein the new inference output comprises a natural language statement that represents a new fact for the new update iteration.

Particular embodiments of the subject matter described in this specification can be implemented so as to realize one or more of the following advantages.

One problem with using a neural network-based approach to make control decisions for controlling, e.g., an agent or manufacturing plant, is that it is often difficult to infer why a particular decision has been made—the neural network is a “black box” that is simply trusted to perform a task. Similarly, when diagnosing a fault in a mechanical system it can be useful to know the reasons behind the response.

Implementations of the described system can address this and other problems by providing a reasoning trace that may be displayed or otherwise provided to a user or stored for later review. This can be particularly useful when the control decisions or fault diagnosis relate to safe operation of a mechanical agent or manufacturing plant or other real-world scenario where interpretable responses are critical. Implementations of the described system can provide a reasoning trace in natural language that is human-interpretable, e.g., as a sequence of logical steps, presented as natural language statements, that lead from the query to the response in a causal chain.

More specifically, by generating the response by repeatedly alternating between two steps: 1) selection, which involves choosing a subset of relevant information sufficient to make a single step of inference; and 2) inference, which only sees the limited information provided to it by the selection output and uses it to infer a new intermediate piece of evidence on the way to producing the final answer, the described techniques ensure that intermediate inference outputs (and, optionally, selection outputs) provide an interpretable reasoning trace to justify the final answer. Moreover, the reasoning produced by the described techniques is causal, since each step follows from and depends on the previous step, and each inference is made in isolation based solely on the limited information provided by the selection output, without direct access to the query input or previous steps of reasoning. This results in a response that is high-quality while at the same time providing a reasoning trace, i.e. an interpretable, natural language “trace” of the reasoning performed by the system while generating the response.

Moreover, the system can dynamically determine, for any given query, when to stop performing update iterations and to provide a response based on the most-recently generated inference output. In so doing, the system can both improve the quality of the responses that are generated as well as reduce the amount of computational resources consumed by the selection-inference process. Additionally, the system can use this “halting” mechanism to determine when to generate a response that indicates that the system cannot accurately answer the query input. This can greatly improve the utility and safety of the system when deployed in real-world environments, for real-world tasks, or both, where precision is prioritized as generating inaccurate responses can have significant negative consequences.

Additionally, this specification describes techniques for maintaining a beam of multiple candidate reasoning traces and determining which traces to update and which candidate to use to generate the final response using a value neural network. By making use of the value neural network, the system can effectively search through the large space of candidate reasoning traces to generate a final response that is accurate by ensuring that candidate reasoning traces that are maintained through the search process are both valid and likely to be included in a ground truth reasoning trace while candidate reasoning traces that are not likely to be valid, not likely to be included in the ground truth, or both are pruned.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example selection-inference system.

FIG. 1B shows the selection-inference system being used to control an agent interacting with an environment.

FIG. 1C shows a simplified example of a selection step and an inference step being performed when the system is used to control a vehicle.

FIG. 1D shows an overview of the operation of the system at a given updating iteration.

FIG. 2 is a flow diagram of an example process for generating a response to a query input.

FIG. 3 shows an example of making use of the halting neural network when the query input includes multiple choices.

FIG. 4 is a flow diagram of an example process for updating a beam of candidate responses to a query input.

Like reference numbers and designations in the various drawings indicate like elements.

### DETAILED DESCRIPTION

This specification describes a system implemented as computer programs on one or more computers in one or more locations that generates a response to a query relating to an environment using context information about the environment.

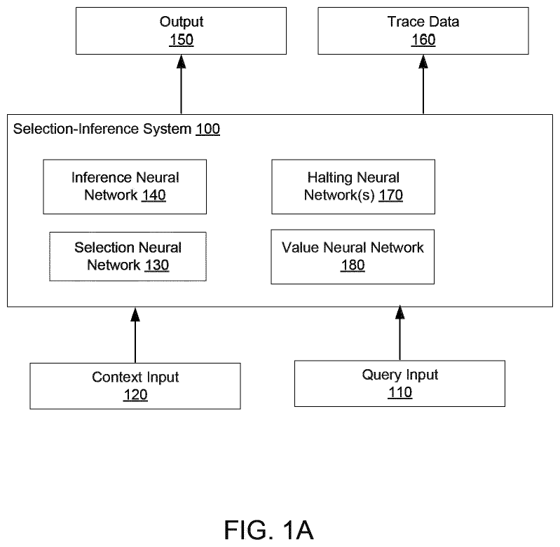

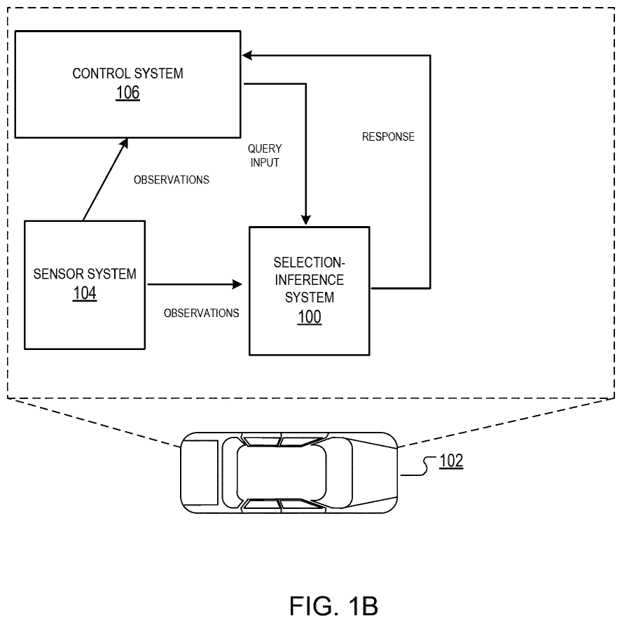

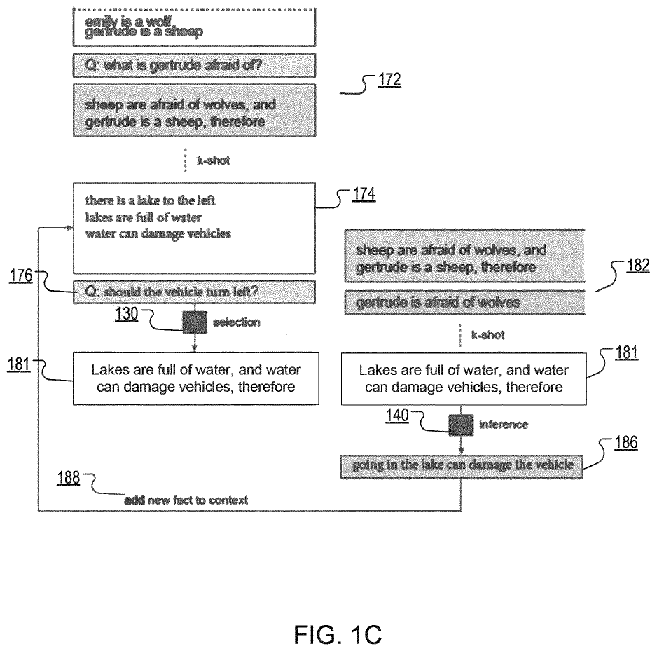

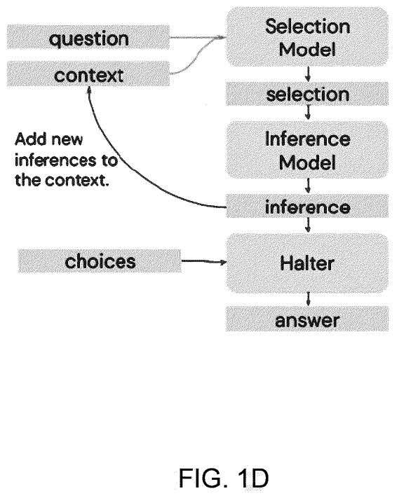

FIG. 1A shows an example selection-inference system 100. The selection-inference system 100 is an example of a system implemented as computer programs on one or more computers in one or more locations, in which the systems, components, and techniques described below can be implemented.

The selection-inference system 100 is a system receives a query input 110 and a context input 120 and generate a response 150 to the query input 110 using the context input 120 by performing update iterations.

The query input 110 includes a query relating to an environment. For example, each query can be a text fragment in a natural language.

The context input 120 includes context information that provides context about the environment. More specifically, the context information in the context input 120 includes one or more natural language statements that each represent a rule or a fact relating to the environment.

In some implementations, the environment is a real-world environment and the system 100 facilitates reasoning in the real-world environment, e.g., to control a real-world system in the environment in a principled and logical manner.

As described later, in some implementations, the system 100 can also provide trace data that includes a causal explanation of why a particular response 150 has been generated, which can facilitate trust in the system, in particular in environments in which safety is important.

For example, in some implementations, the environment is a real-world environment, and the response 150 is used for controlling a mechanical agent, such as a robot or autonomous or semi-autonomous vehicle, acting in the real world environment, to perform a task.

FIG. 1B shows an example of the operation of the selection-inference system 100 when the environment is a real-world environment being navigated by a mechanical agent 102.

In the example of FIG. 1B, the agent 102 is shown as a vehicle. However, more generally, the mechanical agent 102 can be any appropriate agent that is controlled by a control system as the agent navigates through the real-world environment.

The agent 102 includes one or more sensors 104 that capture observations of the environment, e.g., at specified time intervals, as the agent 102 navigates through the environment.

For example, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

The agent 102 is also associated with a control system 106 that generates control signals for controlling the agent 102 using the observations generated by the sensors 104. In particular, the control system 106 generates control signals that cause the agent 102 to follow a planned trajectory through the environment by first determining an appropriate action for the agent 102 to perform, e.g., as part of performing a specified task, e.g., navigating to a particular location, identifying a particular object, moving a particular object to a given location, manipulating a particular object in some way, and so on, and then generating control signals that cause the agent 102 to perform the action.

The control system 106 can be deployed on-board the agent 102 or can be deployed remotely from the agent 102 and can transmit the control signals to the agent 102 over a data communication network.

The control signals can be control inputs to control the agent. For example, when the agent is a robot the control signals can be, e.g., torques for the joints of the robot or higher-level control commands. As another example, when the agent is an autonomous or semi-autonomous land, air, sea vehicle, the control signals can include actions to control navigation, e.g., steering, and movement of the vehicle, e.g., braking and/or acceleration of the vehicle. For example, the control signals can be, e.g., torques to the control surface or other control elements, e.g., steering control elements of the vehicle, or higher-level control commands.

In other words, the control signals can include for example, position, velocity, or force/torque/acceleration data for one or more joints of a robot or parts of another mechanical agent.

In these examples, like the control system 106, the system 100 can be deployed on-board the agent 102 or can be deployed remotely from the agent 102.

In these implementations, the system 100 is used to provide an additional layer of control on top of the control system 106 and the system 100 or another component can determine the query input 110 based on information received by the control system 106.

That is, the query input 110 may be determined by receiving a control signal from the agent control system 106, and then determining one or more natural language queries, e.g., relating to the agent 102 in the environment, from the control signal.

In some implementations, the agent control system 106 is an autonomous or semi-autonomous control system, e.g., that autonomously or semi-autonomously controls the navigation of the agent 102.

In some other implementations, the agent control system 106 has an interface to receive control commands, e.g., from a human operator.

In both of these applications the described system 100 may be used to provide an additional layer of control, e.g., for safety purposes. For example the described system 100 may be used to inhibit control of the mechanical agent 102 in a way that could be dangerous or contrary to one or more rules.

One or more rules relating to control of the agent may be entered explicitly, e.g., as part of the context input, or may be implicit, e.g., included as natural language statements when training the neural networks used by the system 100, in particular when these each comprise a language model as described later. As one example, such rules may include rules relating to permitted movement of a vehicle, such as traffic rules. As another example such rules may include rules relating to decisions to be made to ensure safe behavior of the mechanical agent, e.g., to inhibit damage to the mechanical agent or to a human.

Thus, each query input 110 may relate to an action to be performed by the agent, e.g., an action that is under consideration by the control system 106.

For example, the query input 110 can define an action to be performed by the mechanical agent 102, e.g., in the form of a question such as “Do I turn left?” or “Is it safe for the agent to turn left?”

As another example, the query input 110 can ask what action is to be performed by the mechanical agent, e.g., “Which way should the agent turn?”

In the case of a robot, the query input 110 can relate to a sub-task of a series of sub-tasks that are to be performed to perform a task, e.g., “What do I do next?” or “Do I pick up object X?”. The sub-tasks may themselves include a series of primitive actions for moving parts of the robot, e.g., to open grippers.

In general, the query input 110 includes one or more natural language queries. More particularly, the query input 110 can include a natural language description that defines information the response from the system 100 is to provide. That is, the query input 110 explicitly or implicitly determines what is required from the response.

The response 150 to the query input 110 is used to control the mechanical agent 102 in the real world environment. More specifically, the response 150 is used to control an action to be performed by mechanical agent 102.

As one example, the response 150 may inhibit an action that would otherwise be performed, i.e., the response may determine whether or not an action defined by the query input is performed.

As another example the response 150 may define an action to be performed, e.g., where the query input implicitly or explicitly requests an action to be determined.

In these implementations, obtaining the context input 120 can include obtaining one or more observations of the real world environment which, because the environment includes the agent, potentially includes one or more observations of the agent. The observations may be obtained from one or more sensors that may, but need not be the sensors 104 of the agent. As described above, the observations may include still or moving images, which, as used here, includes LIDAR point clouds, and/or other sensor data from one or more sensors sensing a state of the environment or agent.

The one or more observations are processed, e.g., by a first machine learning model, to generate a natural language representation of the one or more observations, i.e., to generate natural language text describing the observation, that is included in the context input 120.

There are many different types of machine learning model that may be used to achieve this. For example so called visual language models are typically configured to describe an image or video using natural language, e.g., to perform an image or video captioning task. More generally, such models can perform many different types of image processing task by formulating the task as a text generation problem, e.g., to detect or classify objects in an image or video. Correspondingly other machine learning models can be trained to generate natural language text describing the data from other types of sensor, e.g., to represent a physical position or force as a natural language statement that describes, e.g., the agent or environment or a part thereof. The natural language representation of the one or more observations is used to provide one or more of the natural language statements in the context input 120.

Additionally, the context input 120 can include one or more rules that relate to the current location of the agent 102 in the environment that are not directly generated from the observations generated by the sensors 104.

For example, the context input 120 can also have rules of common knowledge, populated from the weights of a trained machine learning model, a driving rules manual, hand-engineered or obtained from a knowledge graph or the Internet. Examples of such rules include “if a car's electrical systems get wet, they will short circuit”, “if a car drives in the direction of something, it will end up there”, “if the car's electrical systems are broken, the car is not safe to drive” and so on. Other examples of such rules include “the speed limit in the current location is 30 mph,” “right turns are allowed after stop at this red light,” “turning across double yellow lines is prohibited,” and so on.

Thus, in these examples, the system 100 can be used to evaluate the consequences of potential actions that are being considered by the control system 106 before they are transmitted as control signals for the agent 102.

In some other implementations, the environment is a real-world environment that includes a manufacturing plant, e.g., a manufacturing plant for manufacturing a product, such as a chemical, biological, or mechanical product, or a food product. As used herein “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines for processing solid or other materials. The manufacturing units are configured such that an intermediate version or component of the product is moveable between the manufacturing units during manufacture of the product, e.g., via pipes or mechanical conveyance. In implementations the system is used for controlling one or more of the manufacturing units or for controlling movement of the intermediate version or component of the product between the manufacturing units.

Thus, in these implementations, obtaining the context input 120 may then comprise obtaining, from one or more sensors, one or more observations of the manufacturing units or of the movement. The sensors may comprise any type of sensor monitoring the manufacturing units or the movement, e.g., sensors configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units such as the mechanical configuration of a unit, or valve configurations; image or video sensors to capture image or video observations of the manufacturing units or of the movement; or any other appropriate type of sensor. In implementations the one or more observations are processed to generate a natural language representation of the one or more observations, e.g., as previously described. The natural language representation of the one or more observations is used to provide one or more of the natural language statements of the context information.

The query input may relate to an action that controls operation of one or more of the manufacturing units or that controls the movement. The response to the query input is used to control operation of one or more of the manufacturing units or to control the movement. For example the response to the query input may be used to control, e.g., minimize, energy or other resource use, or to control the manufacture to obtain a desired quality or characteristic of the product. For example the actions may include actions that control items of equipment of the plant or actions that change settings that affect the manufacturing units or the movement of the product or intermediates or components thereof, e.g., to adjust or turn on/off items of equipment or manufacturing processes.

In some implementations the manufacturing plant has a plant control system to control the manufacturing units or to control the movement. The query input may be generated by receiving a control signal from the plant control system and generating one or more natural language queries for the query input from the control signal. In a similar way to that previously described the plant control system may be autonomous, semi-autonomous, or human-controlled.

In a similar way to that previously described the system may implement rules, e.g., to control or limit energy or other resource allocation, or to ensure a target quality or characteristic of the product, or to constrain operation of the plant, e.g., of the manufacturing units, within safe bounds.

In some implementations the environment is a real-world environment and the method is used for diagnosing a fault in a mechanical system operating in the real world environment. Then obtaining the context input may comprise obtaining from one or more sensors, e.g., as previously described, one or more observations of the mechanical system (which here includes observations of the operation of the mechanical system). These are processed, e.g., as previously described, to generate a natural language representation of the one or more observations that is used to provide one or more of the natural language statements of the context information. In these implementations the query input relates to the operation of the mechanical system and the response to the query input is used to identify a fault in the mechanical system. For example the query input may comprise a general query such as “Is the system working correctly?” or “What is wrong with the system?” or a specific query such as “Is there a fault with component X?”.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. Then, obtaining the context input can include obtaining observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open. These are processed, e.g., as previously described, to generate a natural language representation of the one or more observations that is used to provide one or more of the natural language statements of the context information. The query input can relate to the operation of the facility, e.g., to adjust the operation one or more electrical components to control, e.g., minimize, use of a resource, such as a task to control use of electrical power or water. For example, the query input can ask which components to turn on to decrease use of the resource or whether it is safe to turn on or off a given component. The system can then determine how to operate the electric components based on the generated response, e.g., by turning on or off one or more components as indicated by the response.

In some implementations the environment is the real-world environment of a power generation facility, e.g., a renewable power generation facility such as a solar farm or wind farm and the query input can relate to how to control power generated by the facility, e.g., to control the delivery of electrical power to a power distribution grid, e.g., to meet demand or to reduce the risk of a mismatch between elements of the grid, or to maximize power generated by the facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment can be an educational environment, e.g., the system can be deployed as part of an education software program that assists a user in learning or practicing one or more corresponding skills. In these examples, the context input 120 can include natural language statements describing or referencing a scenario or scene in a real-world or imagined environment, and the query input 110 can be a question about the scenario or scene that requires logical reasoning. As described below, the trace data generated by the system 100 as part of generating the response 150 can be used to provide insight to the user about the logical reasoning required to generate the response 150. That is, the trace data generated by the system 100 can be used to produce explanations of questions and their corresponding responses to assist a user in learning one or more skills.

As a particular example, the education software program can generate a question and accompanying context information (or receive this data from an external source). An example of such a question may be, e.g., “Why does an astronaut need an oxygen backpack?” The system 100 (given a context of elemental facts) could produce a reasoning trace like the following to assist a user in understanding the concept: “(1) Humans need oxygen to survive. There is no oxygen in space. Therefore, humans need a supply of oxygen to survive in space. (2) Oxygen can be supplied to astronauts through an oxygen backpack and humans need a supply of oxygen to survive in space. Therefore, humans can use an oxygen backpack to help astronauts survive in space.”

As another example, the environment can be an information retrieval environment, e.g., the system can be deployed as part of a search engine or other software that allows a user to search for information in a corpus of documents, e.g., the Internet or another electronic document corpus. In these examples, the query input 110 can be any appropriate natural language query, and the context input 120 can include relevant statements from the corpus of documents, i.e., as identified by searching the corpus using conventional information retrieval techniques. The system 100 can then use the context input 120 to generate the response 150 to the query input 110 in a manner that allows a user to view a trace of the logical reasoning required to generate the response 150, i.e., to increase the confidence of the user in the veracity of the response 150 generated by the system 100.

As another example, the environment can be a software testing or evaluation environment, e.g., the system can be deployed as part of a system that tests software before deployment or evaluates already-deployed software to identify bugs. In these examples, when the system tests software before deployment, the query input 110 can be a natural language query about whether the software will execute as intended, and the context input 120 can include code snippets from the software code and, optionally, natural language statements describing the computer system on which the software will execute. The system 100 can then use the context input 120 to generate the response 150 to the query input 110 that indicates whether the code will execute as intended in a manner that allows a user to view a trace of the logical reasoning required to generate the response 150, i.e., to increase the confidence of the user in the veracity of the response 150 generated by the system 100, e.g., to identify which snippets the system focused on in determining whether execution would proceed as intended. When the system monitors the execution of code after deployment, the query input 110 can be a natural language query about whether a software program or a portion of a software program has executed as intended, and the context input 120 can include one or more of: code snippets from the software code, system logs, program logs, or other artifacts that should be left on the computer by running the program, or verification rules that represent requirements for the execution of the software program, or natural language statements describing the computer system on which the software executes. The system 100 can then use the context input 120 to generate the response 150 to the query input 110 that indicates whether the code has executed as intended, optionally including a reasoning trace that allows a user to view a trace of the logical reasoning required to generate the response 150, i.e., to increase the confidence of the user in the veracity of the response 150 generated by the system 100, e.g., to identify which snippets the system focused on in determining whether execution would proceed as intended. As a particular example, software program can be part of the boot up of a computer, and the system can generate a response each time that the computer starts up to verify whether the computer will function correctly after start up.

As another example, the environment can be a computer security monitoring environment, e.g., the system can be deployed as part of a system that monitors the security of one or more computers. For example, the environment may be a computer network security monitoring environment, and the system can be deployed as part of a system that monitors the security of one or more computers on a computer network, e.g., a wireless network, a cellular network, a local area network and/or the internet. As another example, the environment may alternatively or additionally be a computer system security monitoring environment, and the system can be deployed as part of a system that monitors the system for the presence of computer viruses and/or an unresolved software vulnerability, e.g., a zero-day exploit. A software vulnerability may be resolved by updating the software (e.g., patching) and/or removing (e.g., uninstalling) the software from the computer system. In these examples, the query input 110 can be a natural language query that queries whether a computer security incident has been resolved (e.g., “has the incident been resolved?” and the context input 120 may comprise relevant statements from system logs, i.e., that are potentially relevant to the event being queried. A computer security incident can be, e.g., a data breach, an unauthorized log-in or other access of a secured system, a detection of a computer virus or detection of a software vulnerability. The incident can be “resolved” when the underlying incident is no longer a threat to the security of the computer system e.g., the computer virus has been removed, the access to the secured system has been removed, the data breach has been mitigated, or the software having the vulnerability has been updated or removed. The system 100 can then use the context input 120 to generate the response 150 to the query input 110 in a manner that allows a user to view a trace of the logical reasoning required to generate the response 150, i.e., to increase the confidence of the user in the veracity of the response 150 generated by the system 100. In particular, the response 150 can be a natural language statement indicating whether the incident has been resolved, optionally including a reasoning trace.

Returning to the description of FIG. 1A, to generate the response 150, the system 100 uses a selection neural network 130 and an inference neural network 140.

More specifically, the system 100 generates the response by performing multiple update iterations.

At each update iteration, the system 100 performs a selection step by using the selection neural network 130 to select a proper subset (i.e. less than all) of the natural language statements in the context input 120.

The system 100 then uses the selected proper subset and the inference neural network 140 to perform an inference step to generate a new natural language statement that represents a new fact, i.e., an “inferred” fact. The fact is referred to as “inferred” because the fact is not present in the context input 120 but is determined from the context input 120 by the system 100.

At each update iteration, the system 100 also determines whether the update iteration should be the last update iteration by determining whether a termination criterion is satisfied.

In particular, the system 100 generates, based on the inference output for the update iteration and the query input, a first halting input and processes the first halting input using a first halting neural network 170 to generate a first halting output that indicates whether the inference output contains information necessary to respond to the query input.

The system 100 determines whether the termination criterion is satisfied based on the first halting output.

For example, the system 100 can determine that the termination criterion is satisfied when the halting output indicates that the inference output contains the information necessary to respond to the query input.

As another example, the system 100 can determine that the termination criterion is satisfied when the halting output indicates that the inference output does not contain the information necessary to respond to the query input but a maximum number of update iterations have been performed.

At each update iteration other than the last update iteration, the system 100 uses the new fact to update the context input 120, i.e., by adding the natural language statement representing the new fact to the context input 120.

At the last update iteration, the system 100 uses the new fact to generate the response 150. For example, the system 100 can provide, as the response 150, a natural language output that is derived from the new natural language statement generated at the last update iteration.

As a particular example, the system 100 generates a second halting input from at least the inference output at the update iteration and processes the second halting input using a second halting neural network 170 to generate a second halting output that identifies the natural language output derived from the natural language statement in the inference output for the last update iteration.

In some implementations, the first and second halting neural networks 170 are the same, i.e., the system 100 uses the same halting neural network 170 to both determine whether to terminate and to generate the final output by querying the neural network 170 with different inputs.

Thus, the system 100 iteratively adds new facts to the context input 120 and then uses the new fact generated at the last update iteration to generate the response 150 to the query input 110.

More specifically, the selection neural network 130 is a neural network that is configured to process a selection input that includes the context input 120 (as of the current update iteration) and the query input 110 to generate a selection output that includes one or more of the natural language statements from the context input 120. Because the context input 120 is updated at each iteration, the selection output can identify different natural language statements at different update iterations.

The inference neural network 140 is a neural network that is configured to process an inference input that includes a selection output to generate an inference output that includes a natural language statement that represents a new fact for the update iteration. Because the selection outputs can be different for different update iterations, the inference outputs can also differ across update iterations.

In some implementations, the inference input does not include the context input 120 or the query input 110. That is, the inference neural network 140 only has access to the proper subset of the context input 120 that is included in the selection output and not the remaining natural language statements in the context input 120 or the query input 110.

Thus, at each update iteration, the system 100 processes a selection input that includes the context input 120 (as of the update iteration) and the query input 110 using the selection neural network 130 to generate a selection output for the update iteration that includes one or more of the natural language statements from the context input 120. These natural language statements can include statements that were included in the original context input obtained by the system 100, statements that were added to the context input at preceding update iterations, or both.

In some implementations, the selection neural network 130 is configured to generate, i.e., regress a text sequence that includes one or more of the natural language statements from the context input 120. In some of these implementations, the system 100 can employ constrained sampling to ensure that tokens that are generated by the neural network 130 are either (i) valid continuations of some natural language statement in the context input 120, (ii) the beginning of another natural language statement in the context input 130, or, optionally (iii) one or more predetermined tokens that denote, e.g., separators between natural language statements or the end of the regressed text sequence.

In some other implementations, the neural network 130 can be configured to generate a text sequence that includes placeholder references to natural language statements in the context input 120, e.g., generating a sentence, e.g., “sent 1. We know that sent 4,” where “sent 1” is a reference to the first sentence in the context input 120 and “sent 4” is a reference to the fourth sentence in the context input 120. The system 100 can then substitute in the actual sentences to generate the selection output.

In yet other implementations, each selection step includes multiple internal steps. At each internal step, the selection neural network 130 is used to add a new statement to the selection output for the selection step.

The system 100 then processes an inference input that includes the selection output for the update iteration using the inference neural network 140 to generate an inference output that includes a natural language statement that represents a new fact for the update iteration. As described above, if the update iteration is not the last update iteration, the system 100 then updates the context input 120 to include the natural language statement in the inference output for the update iteration.

In some implementations, during the generation of a response, the system 100 can maintain a “beam” of multiple candidate reasoning traces. The system 100 can use a value neural network 180 to determine, after each (unfinalized) candidate in the beam has been updated to generate one or more updated candidates, which candidates should be kept in the beam and which should be discarded. The system 100 can also use the value neural network 180 to determine, after all of the candidates in the beam have been finalized or after a different termination criterion has been satisfied, which of the candidates to use to generate the final response to the query input.

Because of the manner in which the system 100 generates the response 150, the system 100 can also provide, as output, trace data 160 that provides an interpretable, natural language summary of the causal reasoning performed by the system 100 to generate the response 150. In particular, because the system 100 alternates between two steps: 1) selection, which involves choosing a subset of relevant information sufficient to make a single step of inference; and 2) inference, which only sees the limited information provided to it by the selection output and uses it to infer a new intermediate piece of evidence on the way to producing the final answer, the system ensures that intermediate inference outputs (and, optionally, selection outputs) provide an interpretable reasoning trace to justify the final answer. Moreover, the reasoning produced by the system 100 is causal, since each step follows from and depends on the previous step, and each inference is made in isolation based solely on the limited information provided by the selection output, without direct access to the query input or previous steps of reasoning. That is, the reasoning trace includes the selection outputs and the inference outputs from each of the updating iterations and the trace data 160 can include the inference outputs and, optionally, the selection outputs from each of the updating iterations.

In some implementations, the system 100 provides the trace data 160 along with the response 150, e.g., to a user. When there are multiple candidate traces maintained in the beam, the system can designate, as the trace data 160, the trace data for the trace that was used to generate the final response. In some other implementations, the system 100 stores the trace data 160 in association with data identifying the response 150.

For example, the trace data 160 can later be accessed by a user that requests to see the “reasoning” performed by the system 100 that resulted in a particular control signal being transmitted to a mechanical agent.

As a simplified example, when the context input 120 indicates that a pedestrian is in the vicinity of the roadway on which an agent is traveling and the query input 110 is “what action to take,” e.g., either “continue driving” or “stop driving,” the trace data can include selection outputs like “There is a person crossing the road,” and “we know that if someone is crossing the road it is not safe to drive” and the inference could be “Therefore, it is not safe to drive”.

As another simplified example, when the context input 120 indicates there is a lake in the vicinity of a vehicle and the query input 110 asks whether the vehicle should drive towards the lake, the trace data 160 can include intermediate inferences like: “therefore the car will end up in the lake”->“lake means wet”->“wet means short circuiting”->“short circuiting means not safe” and the response 150 could be “we should not drive forward.”

The selection neural network 130 can generally have any appropriate architecture that allows the neural network to be used to map a selection input to a proper subset of the context input 120. Similarly, the inference neural network 140 can generally have any appropriate architecture that allows the neural network to be used to map an inference input to a new natural language statement.

As a particular example, both the selection neural network 130 and the inference neural network 140 can be respective language model neural networks. In general, a language model neural network is a neural network that has been trained so that, given a text prompt that includes a sequence of tokens in a natural language, the neural network can generate the next token in the sequence. This process can be repeated to extend the text prompt one token at a time to generate a natural language output, i.e., to generate the natural language output auto-regressively token by token. At each time “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data.

It is surprising, but well-established, that large language model neural networks can perform tasks that they were not explicitly trained to perform. For example they can perform translation tasks (provided that the training corpus included words in different languages), arithmetic, and many other tasks.

A language model neural network can be made to perform a particular task by providing a natural language description of the desired response as an input or “prompt”. In some cases, the prompt may be a few-shot prompt where a few, e.g., 1 to 10, examples of a query and an example output are provided in the text prior to the actual query.

Instead or in addition, a language model neural network may be “fine-tuned” to perform a particular task, by obtaining a pre-trained language model neural network trained on a large corpus of examples as previously described and then further training part of all of the language model neural network on a relatively small number of examples particular to the type of task that is to be performed.

Thus, a trained language model neural network can perform control and diagnosis tasks of the type described. Where the system is to comply with rules in generating the response these may be included in the context information, e.g., in the prompt, and or as statements in the corpus of training data or in data used to fine tune the language model neural network.

In other words, in some implementations, the selection neural network 130 and the inference neural network 140 are the same, pre-trained language model neural network. In these implementations, each selection input includes one type of few shot prompt that causes the language model to generate a selection output and each inference input includes a different type of few shot prompt that causes the language model to generate an inference output.

For example, the few-shot prompt for the inference neural network 140 can include one or more example inference input-inference output pairs arranged according to a predetermined syntax (followed by the subset of the context input identified by the corresponding selection output) while the few-shot prompt for the selection neural network 130 can include one or more example selection input-selection output pairs arranged according to a predetermined syntax (followed by the context input and the query input arranged according to a predetermined syntax).

For example, the few shot prompt in each selection input can be of the form:

# n-shot prompt
# First example.
<context 1>
<query 1>
# Example selection
<fact>. We know that <fact>[ and <fact>]*. Therefore,
...
# Problem to solve.
<context>
<query>

In this example, statements that follow a # are not included in the prompt (or are optional) and are only included in the example for explanation, <context> represents the natural language text in a context input, <query> represents a query input, the “ . . . ” indicates that the First example is followed by one or more additional examples in the same format, each <fact> is a natural language statement copied from the corresponding context and [and <fact>]* means that the system can select more than one fact for each step of inference, where the total number of facts in a given inference step is a hyper-parameter.

As another example, the few shot prompt in each inference input can be of the form:

#n-shot inference prompt
# First example.
<fact>. We know that <fact>[ and <fact>]*. Therefore, <new fact>.
...
# Problem to solve.
<output of the Selection step>. Therefore,

In this example, the <new fact> in each example in the prompt is an inferred fact that is generated (“inferred”) from the <fact>s in the example, and the <output of the Selection step> are the one or more facts in the selection output for the selection step formatted in the same way as the examples in the few shot prompt.

The language model neural network may be a large language model neural network, e.g., one that has greater than 1 billion, 10 billion or 100 billion trained parameters. The language model neural network may have been trained on greater than 10 billion, 100 billion or 1000 billion words or tokens representing words or other text tokens, e.g., sub-words (also known as “word pieces”).

In some other implementations, the selection neural network 130 and the inference neural network 140 are both language model neural networks that have the same architecture and that were pre-trained on the same large corpus, but the selection neural network 130 was fine-tuned on a first data set of example selection input-selection output pairs, the inference neural network 140 was fine-tuned on a second data set of example inference input-selection input pairs, or both. For example, fine-tuning the selection neural network 130 can allow the selection neural network 130 to more effectively generate outputs that include placeholder references to facts from the context input as described above.

In some of these implementations, each selection input and each inference output each include a respective few-shot prompt while, in others of these implementations, no few-shot prompt is included.

In some implementations, the language model neural network is an autoregressive transformer neural network, where a transformer neural network is characterized by having a succession of self-attention neural network layers. A self-attention neural network layer has an attention layer input for each element of the input and is configured to apply an attention mechanism over the attention layer input to generate an attention layer output for each element of the input; there are many different attention mechanisms that may be used. In some implementations the language model neural network can be a mixture-of-experts model.

The halting neural network(s) 170 and the value neural network 180 can also be language model neural networks, e.g., having any of the forms described above.

That is, the one or more halting neural networks 170 and the value neural network 180 can be configured to generate an output of the type required by including, in the input to the neural network, a corresponding prompt, e.g. a few-shot prompt, or by virtue of being fine-tuned on a fine-tuning data set, or both. Some example prompts are given later.

FIG. 1C shows a simplified example of a selection step and an inference step being performed when the system 100 is used to control a vehicle, e.g., an autonomous or semi-autonomous vehicle.

In the example of FIG. 1C, the query input 176 is “should the vehicle turn left?” and the context input 174 (as of the example selection step shown in FIG. 1C) is “there is a lake to the left, lakes are full of water, water can damage vehicles.” To perform the selection step, the system 100 generates a selection input that includes a k-shot prompt 172 (a portion of the example context for one of the examples in the k-shot prompt 172, an example query input for the example, and an example selection output for the example are shown in FIG. 1C), the context input 174, and the query input 176. The system 100 uses the selection neural network 130 to process the selection input to generate a selection output 181 that states “lakes are full of water, and water can damage vehicles, therefore.”

The system 100 then generates an inference input that includes a k-shot prompt (one of the examples 182 in the k-shot prompt is shown in FIG. 1C) and the selection output 181. The system 100 uses the inference neural network 140 to process the inference input to generate an inference output 186 that is a new inferred fact, i.e., that states “going in the lake can damage the vehicle.” The system 100 then adds 188 the new inferred fact to the context input 174 for use in the next selection step.

FIG. 1D shows an overview of the operation of the system at a given updating iteration.

As shown in FIG. 1D, the system 100 receives a question and a context. The system also receives a set of natural language choices and the question indicates that the response should be to select one of the natural language choices.

At each updating iteration, the system processes the question and the context as of the updating iteration using the selection neural network 130 to generate a selection output.

The system then processes the selection output using the inference neural network 140 to generate an inference output.

The system then processes a halting input generated from the inference output using a halting neural network 170 to determine whether termination criteria are satisfied.

If the termination criteria are not satisfied, the system adds the new fact from inference output to the context.

If the termination criteria are satisfied, the system processes the choices and the inference output using the same halting neural network 170 or a different halting neural network 170 to generate the answer to the question.

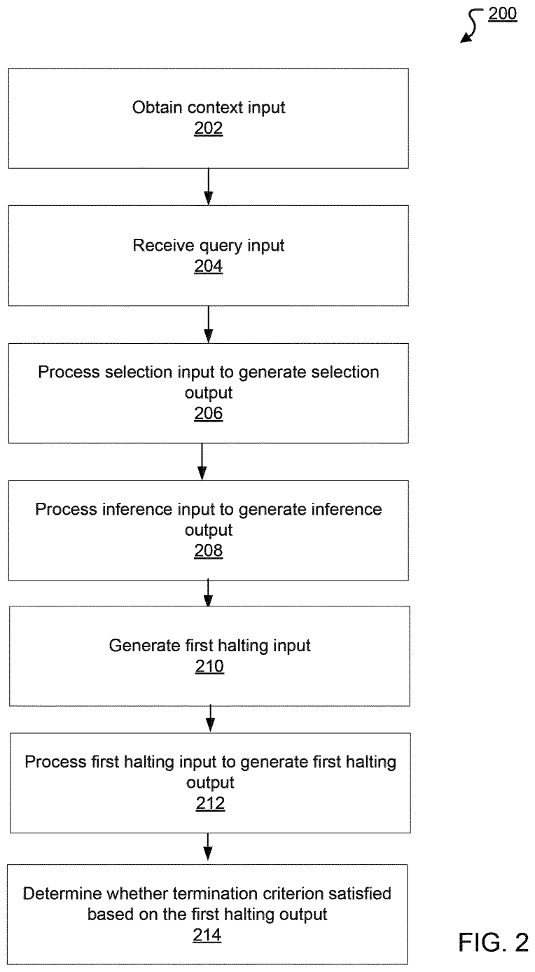

This is described in more detail below with reference to FIG. 2.

FIG. 2 is a flow diagram of an example process 200 for generating a response to a query input. For convenience, the process 200 will be described as being performed by a system of one or more computers located in one or more locations. For example, a data generation system, e.g., the selection-inference system 100 depicted in FIG. 1A, appropriately programmed in accordance with this specification, can perform the process 200.

The system obtains a context input that includes context information (step 202). Generally, the context information includes one or more natural language statements that each represent a fact or a rule relating to an environment.

The system receives a query input that includes a query relating to the environment (step 204).

The system then generates a response to the query input by performing update iterations until a termination criterion is satisfied.

In particular, at each update iteration, the system performs steps 206-214.

The system processes a selection input that includes the context input and the query input using a selection neural network to generate a selection output for the update iteration (step 206). As described above, the selection output includes one or more of the natural language statements from the context input.

The system processes an inference input that includes the selection output for the update iteration using an inference neural network to generate an inference output for the update iteration (step 208). As described above, the inference output includes a natural language statement that represents a new fact for the update iteration.

The system generates, based on the inference output for the update iteration and the query input, a first halting input (step 210). The first halting input will be described in more detail below.

The system processes the first halting input using a first halting neural network to generate a first halting output that indicates whether the inference output contains information necessary to respond to the query input (step 212).

The system determines whether the termination criterion is satisfied based on the first halting output (step 214).

For example, the system can determine that the termination criterion is satisfied when the halting output indicates that the inference output contains the information necessary to respond to the query input.

As another example, even if the halting output indicates that the inference output does not contain the information necessary, the system can determine that the termination criterion is satisfied when a maximum number of update iterations have been performed. That is, the system determines that the termination criterion is satisfied when the halting output indicates that the inference output does not contain the information necessary to respond to the query input but a maximum number of update iterations have been performed.

If the termination criterion is satisfied, the system sets the current updating iteration as the last updating iteration, i.e., does not perform any more updating iterations, and provides a response to the query input.

For example, if the termination criterion is satisfied because the inference output does not contain the information necessary to respond to the query input but the maximum number of update iterations have been performed, the system can generate a natural language output that indicates that the query has not been answered, e.g., “no answer available” or “response not found” or “unknown.”

As another example, in response to determining that the halting output indicates that the inference output does contain the information necessary to respond to the query input, the system provides, as the response, a natural language output derived from the natural language statement in the inference output for the last update iteration.

Optionally, the system can also provide, as part of the response, a reasoning trace that includes the respective natural language statement in the inference output at each update iteration other than the last update iteration. That is, the reasoning trace may include the respective natural language statement in the inference output at each update iteration other than the last update iteration. The reasoning trace can optionally also include the selection outputs for the update iterations.

In some implementations, the system generates the natural language output that is derived from the natural language statement in the inference output for the last update iteration by applying a predetermined rule to the natural language statement in the inference output.

In some other implementations, the system generates a second halting input from at least the inference output at the update iteration and processes the second halting input using a second halting neural network to generate a second halting output that identifies the natural language output derived from the natural language statement in the inference output for the last update iteration.

For example, the first and second halting neural network can be the same neural network, e.g., the same language model neural network as described above, and the system can cause the neural network to generate the second halting output by including, as part of the second halting input, a specified prompt.

That is, when both the first and second halting neural networks are the same language model neural network, the first halting input used to determine whether the inference output contains the information necessary to respond to the query includes a first halting text prompt and the second halting input used to generate natural language output includes a second, different halting text prompt.

For example, the first halting text prompt can be of the form “Question: {question} Given {inference}. Do you know the answer?” In this example, “question” is the text of the query input and {inference} is the natural language statement in the inference output. The halting neural network can then output either a first natural language output that indicates that the answer is known (and therefore, that the inference output does contain the information necessary to respond to the query input), e.g., “yes” or “definitely” or “I do,” or a second natural language output that indicates that the answer is not known (and therefore, that the inference output does not contain the information necessary to respond to the query input), e.g., “no” or “not sure” or “I don't.” As a particular example, the system can determine that the inference output does contain the information necessary to respond to the query input when the score, e.g., the log likelihood, assigned to the first natural language output by the first halting neural network is higher than the score assigned to the second natural language output by the halting neural network. As another particular example, the system can determine that the inference output does contain the information necessary to respond to the query input when the score, e.g., the log likelihood, assigned to the first natural language output exceeds a predetermined threshold.

Optionally, the halting prompt can also include one or more examples, i.e., can be a k-shot prompt as described above.

The system can use any of a variety of different forms of second halting prompts. For example, the second halting prompt use can depend on the form of the query that is received as input.

As a particular example, the query input can include, along with the query relating to the environment, a plurality of natural language choices that are possible responses to the query.

In this example, the second halting input can include the plurality of natural language choices and the second halting output can identify one of the plurality of natural language choices as the natural language statement.

As an example, the second halting input can be of the form “Given {inference}. Which of the following most closely matches: {choices}? Answer:” where {choices} identifies the multiple choices in the query input. The system can then select the natural language choice to which the halting neural network assigns the highest score as the natural language statement to be included in the response.

As another particular example, the query can ask if a particular statement is true or false. In this example, the second halting input can be of the form “Given {inference}. Is {statement} true or false? Answer:” where {statement} is the statement from the query. The system can then select, between “true” and “false,” the choice to which the halting neural network assigns the highest score as the natural language statement to be included in the response.

Optionally, the halting prompt can also include one or more examples, i.e., can be a k-shot prompt as described above.

If the termination criterion is not satisfied, e.g., if the halting output indicates that the inference output does not contain the information necessary but the maximum number of update iterations have not yet been performed, the system updates the context input to include the natural language statement in the inference output for the update iteration.

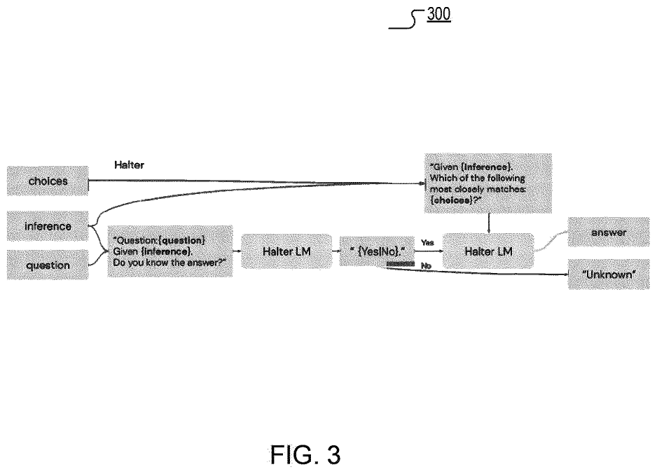

FIG. 3 shows an example 300 of making use of the halter neural network when the query input includes multiple choices.

As shown in FIG. 3, after the selection-inference step has been performed to generate the inference output, the system provides a first halting input that includes the first halting prompt, the question, and the natural language statement from the inference output as input to the halter neural network.

The system then selects either “yes” or “no” as the output of the halter neural network.

If the system selects “no” and the maximum number of updating iterations have already been performed, the system outputs that the response to the question is “Unknown.”

If the system selects “yes,” the system generates a second halting input to the halting neural network that includes the second halting prompt, the choices, and the inference output and provides the output of the halting neural network as the answer to the question.

In some implementations, as described above, during the generation of a response, the system can maintain a “beam” of multiple candidate reasoning traces.

In these implementations, the system can use a value neural network to determine, after each (unfinalized) candidate in the beam has been updated to generate one or more updated candidates, which candidates should be kept in the beam and which should be discarded. A candidate in the beam is considered to be finalized if the system has determined that a termination criterion is satisfied for the candidate, e.g., using the halting neural network as described above with reference to FIG. 2.

The system can also use the value neural network to determine, after all of the candidates in the beam have been finalized or after a different termination criterion has been satisfied, which of the candidates to use to generate the final response to the query input.

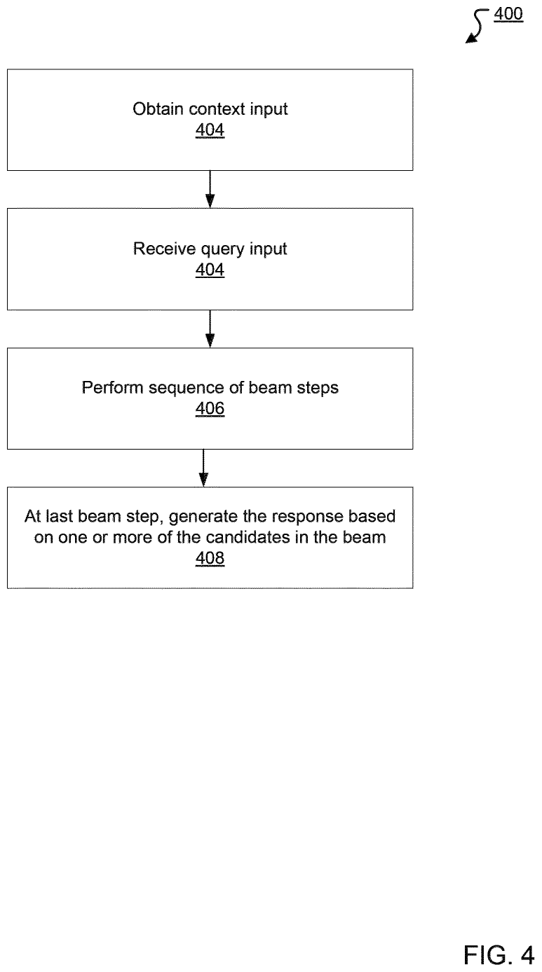

FIG. 4 is a flow diagram of an example process 400 for updating a beam of candidate responses to a query input. For convenience, the process 400 will be described as being performed by a system of one or more computers located in one or more locations. For example, a data generation system, e.g., the selection-inference system 100 depicted in FIG. 1A, appropriately programmed in accordance with this specification, can perform the process 400.

The system obtains a context input (step 402). As described above, the context input includes context information that, in turn, includes one or more natural language statements that each represent a fact or a rule relating to an environment.

The system receives a query input that includes a query relating to the environment (step 404).

The system generates a response to the query input conditioned on the context input by performing a sequence of one or more beam steps (step 406).

Generally, at any given one of the beam steps, the system obtains a plurality of candidate reasoning traces generated by a selection-inference system as part of generating a response to the query input conditioned on the context input.

The selection-inference system can be any appropriate system that generates reasoning traces in response to query and context inputs. For example, the selection-inference system can operate as described with reference to FIGS. 1A-3.

As described above, each candidate reasoning trace includes, for each of one or more update iterations, a respective selection output for the update iteration and a respective inference output for the update iteration.

That is, each of the candidate reasoning traces was generated by the selection-inference system from a corresponding one of the candidate reasoning traces that were in a beam at the end of the preceding beam step, i.e., by performing an update iteration on the corresponding candidate reasoning trace, or, for the first beam step, were generated by performing an initial updating iteration starting from the context input and the query input.

The system then maintains at most a predetermined number of the candidate reasoning traces in the beam for further consideration by the selection-inference system.

In particular, to determine which candidates to maintain, the system processes each candidate reasoning trace using a value neural network to generate a respective score for the candidate reasoning trace.

The score for a candidate reasoning trace estimates a likelihood that the candidate reasoning trace is a valid reasoning trace that is included in a ground truth reasoning trace that results in a ground truth response to the query input.

A reasoning trace is “valid” when the reasoning trace is logically valid, i.e., each inference output in the reasoning trace is derivable from the corresponding selection output.

A ground truth response to the query input is a response that correctly answers the query posed by the query input.

Thus, the ground truth reasoning trace is a valid reasoning trace in which the last inference output contains the information necessary to respond to the query input, i.e., to generate the ground truth response to the query input. In some cases, the system requires that a ground truth reasoning trace is one that includes the minimum number of reasoning steps from among the set of all valid reasoning trace in which the last inference output contains the information necessary to respond to the query input.

As described above, the value neural network can be a language model neural network. In these examples, the system can determine the score for a given candidate reasoning trace by determining the score, e.g., log likelihood, assigned to a predetermined natural language output that indicates that the candidate reasoning trace is valid by the value neural network by processing the candidate reasoning trace. For example, the predetermined natural language output can be “correct” or “valid” or another such natural language statement.

In other words, as described above, the value neural network is configured to process the candidate reasoning trace to generate a value output that specifies a probability distribution over a vocabulary of tokens, and the score for the candidate reasoning trace is based on a probability assigned by the probability distribution to a predetermined token from the vocabulary. That is, when the predetermined natural language output is represented by the single token, the score can be based only on the probability for the single token. When the predetermined natural language output is represented by multiple tokens, the score can be based on the probability for the first token of the multiple tokens, e.g., so that the score is the log of the probability for the first token, or on the probability for the first token and subsequent probabilities for subsequent tokens in subsequent probability distributions generated by the value neural network, e.g., the log of the product of the first probability and the subsequent probabilities.

As a particular example, the input to the value neural network can include a k-shot prompt that causes the value neural network to generate one of the predetermined natural language outputs by processing the reasoning trace.

As another particular example, the value neural network can be a pre-trained language model that has been fine-tuned to cause the value neural network to accurately determine whether candidate reasoning traces are “correct.”

For example, the value neural network can have been trained on training examples that each include (i) a respective partial reasoning trace and (ii) a label indicating whether the partial reasoning trace was a valid reasoning trace included in a corresponding complete reasoning trace. In these examples, the positive label that indicates that the partial reasoning trace is valid can be the predetermined natural language output.

The system can then rank the candidate reasoning traces based on the respective scores and remove from the beam all candidate reasoning traces other than the predetermined number of highest-ranked candidate reasoning traces according to the ranking.

Generally, the system continues performing beam steps until the last beam step is reached.

The last beam step is one where each candidate reasoning trace that was not removed from the beam has been finalized, i.e., each candidate reasoning trace that remains in the beam after the ranking and removal has been performed is a finalized candidate reasoning trace.

When a given beam step is not the last beam step in the sequence, i.e., when the system determines that at least one of the candidate reasoning traces that were not removed from the beam has not been finalized, the system causes the selection-inference system to generate, for each candidate reasoning trace that was not removed from the beam and that is not finalized, a respective selection output for a new update iteration that follows a last update iteration in the candidate reasoning trace and a respective inference output for the new update iteration, e.g., as described above. The new selection and inference outputs can then be used to update the candidate reasoning traces to generate the candidate reasoning traces for the next beam step. In some cases, the system can cause the selection-inference system to generate multiple updated candidate reasoning traces for each candidate reasoning traces that was not removed from the beam and that has not been finalized, e.g., by sampling from the probability distributions generated by the selection and inference neural networks.

The system can also cause the selection-inference system to determine, for each candidate reasoning trace, whether the candidate reasoning traces have become finalized, e.g., by performing steps 210-214 described above with reference to FIG. 2.

That is, more generally, the system can cause the selection-inference system to perform one or more iterations of the process 200 for each un-finalized candidate reasoning trace in the beam to generate one or more updated candidate reasoning traces from each of the un-finalized candidates.

At the last beam step, the system generates the response based on one or more of the candidate reasoning traces in the beam (step 408). For example, the system can generate the response based on the highest-ranked candidate reasoning trace according to the ranking generated at the last beam step. As a particular example, the system can use the second halting neural network to generate the response from the last inference output in the highest-ranked candidate reasoning trace as described above with reference to FIGS. 2 and 3.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a context input comprising context information, the context information comprising one or more natural language statements that each represent a fact or a rule relating to an environment;
receiving a query input comprising a query relating to the environment;
generating a response to the query input by performing update iterations until a termination criterion is satisfied, the generating comprising, at each update iteration:
processing a selection input comprising the context input and the query input using a selection neural network to generate a selection output for the update iteration that comprises one or more of the natural language statements from the context input;
processing an inference input comprising the selection output for the update iteration using an inference neural network to generate an inference output that comprises a natural language statement that represents a new fact for the update iteration;
generating, based on the inference output for the update iteration and the query input, a first halting input;
processing the first halting input using a first halting neural network to generate a first halting output that indicates whether the inference output contains information necessary to respond to the query input; and
determining whether the termination criterion is satisfied based on the first halting output.

2. The method of claim 1, the generating further comprising, in response to determining that the termination criterion is not satisfied:
updating the context input to include the natural language statement in the inference output for the update iteration.

3. The method of claim 1, further comprising:
determining that the termination criterion is satisfied when the halting output indicates that the inference output contains the information necessary to respond to the query input.

4. The method of claim 1, further comprising:
determining that the termination criterion is satisfied when the halting output indicates that the inference output does not contain the information necessary to respond to the query input but a maximum number of update iterations have been performed.

5. The method of claim 4, the generating further comprising:
in response to determining that the inference output does not contain the information necessary to respond to the query input but a maximum number of update iterations have been performed, providing, as the response, a natural language output that indicates that that the query has not been answered.

6. The method of claim 1, further comprising:
in response to determining that the halting output indicates that the inference output does contain the information necessary to respond to the query input, providing, as the response, (i) a natural language output derived from the natural language statement in the inference output for the last update iteration.

7. The method of claim 6, wherein the response further comprises (ii) a reasoning trace that comprises the natural language statement in the inference output at each update iteration other than the last update iteration.

8. The method of claim 7, wherein the reasoning trace further comprises the selection outputs for the update iterations.

9. The method of claim 6, further comprising:
generating a second halting input from at least the inference output at the update iteration; and
processing the second halting input using a second halting neural network to generate a second halting output that identifies the natural language output derived from the natural language statement in the inference output for the last update iteration.

10. The method of claim 9, wherein the second halting neural network is the same neural network as the first halting neural network.

11. The method of claim 10, wherein the first and second halting neural networks are a language model neural network, wherein the first halting input includes a first halting text prompt and wherein the second halting input includes a second, different halting text prompt.

12. The method of claim 9, wherein the query input further comprises a plurality of natural language choices, wherein the second halting input further comprises the plurality of natural language choices, and wherein the second halting output identifies one of the plurality of natural language choices as the natural language statement.

13. The method of claim 1, wherein the inference input does not include the query input or any natural language statements from the context input that are not included in the selection output for the update iteration.

14. A method performed by one or more computers, the method comprising:
obtaining a context input comprising context information, the context information comprising one or more natural language statements that each represent a fact or a rule relating to an environment;
receiving a query input comprising a query relating to the environment; and
generating a response to the query input conditioned on the context input, comprising, at each beam step of a sequence of one or more beam steps:
obtaining a plurality of candidate reasoning traces generated by a selection-inference system as part of generating a response to the query input conditioned on the context input, each candidate reasoning trace comprising, for each of one or more update iterations, a respective selection output for the update iteration and a respective inference output for the update iteration; and
maintaining at most a predetermined number of the candidate reasoning traces in a beam for further consideration by the selection-inference system, comprising:
processing each reasoning trace using a value neural network to generate a respective score for each reasoning trace that estimates a likelihood that the candidate reasoning trace is a valid reasoning trace that is included in a ground truth reasoning trace that results in a ground truth response to the query input;
ranking the candidate reasoning traces based on the respective scores; and
removing from the beam all candidate reasoning traces other than the predetermined number of highest-ranked candidate reasoning traces according to the ranking.

15. The method of claim 14, wherein generating the response further comprises:
at a last beam step in the sequence, determining that each candidate reasoning trace that was not removed from the beam has been finalized and, in response, generating the response based on the highest-ranked candidate reasoning trace.

16. The method of claim 14, wherein the value neural network is configured to generate a value output that specifies a probability distribution over a vocabulary of tokens, and wherein the score is based on a probability assigned by the probability distribution to a predetermined token from the vocabulary.

17. The method of claim 16, wherein the value neural network is a language model neural network.

18. The method of claim 14, wherein the value neural network has been trained on training examples that each comprise (i) a respective partial reasoning trace and (ii) a label indicating whether the partial reasoning trace was a valid reasoning trace included in a corresponding complete reasoning trace.

19. The method of claim 14, further comprising:
at each beam step other than the last beam step in the sequence, determining that at least one of the candidate reasoning traces that were not removed from the beam has not been finalized and, in response, causing the selection-inference system to generate, for each candidate reasoning trace that was not removed from the beam and that is not finalized, a respective selection output for a new update iteration that follows a last update iteration in the candidate reasoning trace and a respective inference output for the new update iteration.

20. The method of claim 14, wherein the selection-inference system is a system that is configured to:
obtain the context input;
receive the query input;
receive a current candidate reasoning trace that includes, for each of one or more update iterations, a respective selection output for the update iteration and a respective inference output for the update iteration; and
perform a new update iteration to update the current candidate reasoning trace to add a new selection output and a new inference output to the candidate reasoning trace, comprising:
processing a selection input comprising (i) the context input, (ii) one or more natural language statements derived from the respective inference outputs in the candidate reasoning trace, and (iii) the query input using a selection neural network to generate the new selection output for the new update iteration that comprises one or more of the natural language statements from the context input, one or more of the natural language statements derived from the respective inference outputs, or both; and
processing an inference input comprising the selection output for the new update iteration using an inference neural network to generate the new inference output, wherein the new inference output comprises a natural language statement that represents a new fact for the new update iteration.

21. The method of claim 1, wherein the environment is a real-world environment and wherein the method is used for controlling a mechanical agent acting in the real world environment to perform a task; wherein
obtaining the context input comprises obtaining, from one or more sensors, one or more observations of the real world environment, and processing the one or more observations to generate a natural language representation of the one or more observations; and wherein
the query input relates to an action to be performed by the agent;
the method further comprising:
using the natural language representation of the one or more observations to provide one or more of the natural language statements of the context information; and
using the response to the query input to control the mechanical agent in the real world environment.

22. The method of claim 21 wherein the mechanical agent has an agent control system to control actions of the mechanical agent, wherein the query input comprises one or more natural language queries, and wherein receiving the query input comprises:
receiving a control signal from the agent control system; and
generating the one or more natural language queries from the control signal.

23. The method of claim 21 wherein the mechanical agent comprises an autonomous or semi-autonomous vehicle navigating in the real-world environment, and wherein the action comprises an action to control movement of the vehicle in the real-world environment.

24. The method of claim 21, wherein:
the environment is a real-world environment,
the context input is derived from at least an observation characterizing a current state of the real-world environment that is generated from measurements from one or more sensors configured to sense the real-world environment,
the query input comprises data characterizing planned navigation of an agent, and
the response to the query input characterizes an action to be performed by the agent in response to the observation.

25. The method of claim 24, wherein the agent is a robot or an autonomous vehicle.

26. The method of claim 24, further comprising:
controlling navigation of the agent based on the response to the query input.

27-33. (canceled)

34. The method of claim 1 wherein the query input comprises a natural language description that defines information the response is to provide.

35. (canceled)

36. A system comprising one or more computers and one or more storage devices storing instructions that when executed by the one or more computers cause the one or more computers to perform operations comprising:
obtaining a context input comprising context information, the context information comprising one or more natural language statements that each represent a fact or a rule relating to an environment;
receiving a query input comprising a query relating to the environment;
generating a response to the query input by performing update iterations until a termination criterion is satisfied, the generating comprising, at each update iteration:
processing a selection input comprising the context input and the query input using a selection neural network to generate a selection output for the update iteration that comprises one or more of the natural language statements from the context input;
processing an inference input comprising the selection output for the update iteration using an inference neural network to generate an inference output that comprises a natural language statement that represents a new fact for the update iteration;
generating, based on the inference output for the update iteration and the query input, a first halting input;
processing the first halting input using a first halting neural network to generate a first halting output that indicates whether the inference output contains information necessary to respond to the query input; and
determining whether the termination criterion is satisfied based on the first halting output.
